(19) United States
(12) Patent Application Publication
(10) Pub. No.: US 2013/0161063 A1
(43) Pub. Date: Jun. 27, 2013

(54) CABLE COMPONENT WITH NON-FLAMMABLE MATERIAL

(71) Applicant: General Cable Technologies Corporation, Highland Heights, KY (US)

(72) Inventors: Rob S. Gould, Cincinnati, OH (US); David M. Fausz, Fort Thomas, KY (US); David P. Camp, II, Florence, KY (US); Scott M. Brown, Independence, KY (US); Brian P. Skocypec, North Attleboro, MA (US)

(73) Assignee: GENERAL CABLE TECHNOLOGIES CORPORATION, Highland Heights, KY (US)

(21) Appl. No.: 13/707,077

(22) Filed: Dec. 6, 2012

Related U.S. Application Data
(60) Provisional application No. 61/567,428, filed on Dec. 6, 2011.

(51) Int. Cl. H01B 11/08; H01B 3/00

(52) U.S. Cl. CPC H01B 11/08; H01B 3/00
USPC 174/113 R; 174/120 R; 174/121 A

(57) ABSTRACT

A cable component that comprises a main body where at least a part of the main body is formed of an insulation material, and at least one non-flammable portion is disposed in the insulation material of the main body. The non-flammable portion forms at least about 25% by volume of the cable component, is flexible, and reduces the amount of the insulation material of the main body, thereby reducing the fuel load in the cable component.

### REFERENCE TO RELATED APPLICATIONS

The present application claims benefit of U.S. Provisional Patent Application No. 61/567,428, filed Dec. 6, 2011. The disclosure of the above-referenced application is hereby incorporated by reference into the present application in its entirety.

### FIELD OF THE INVENTION

The present invention relates to components for cables, such as riser and plenum cables, that include non-flammable material, such as fiberglass, for flame and burn resistance.

### BACKGROUND OF THE INVENTION

Conventional communication cables for both riser and plenum applications typically include a number of insulated conductors that are twisted together in pairs 100 and surrounded by an outer jacket 102, as seen in FIG. 1. Crosstalk or interference often occurs because of electromagnetic coupling between the twisted pairs within the cable or other components in the cable, thereby degrading the cable's electrical performance. Also, as networks become more complex and have a need for higher bandwidth cabling, reduction of cable-to-cable crosstalk (alien crosstalk) becomes increasingly important.

Barriers or separators, such as the separator 110 shown in FIG. 1, are often used, particularly in plenum applications, to separate and isolate the pairs of conductors, thereby reducing crosstalk interference. Such barriers and separators are normally made of a flame retardant insulation material or insulation materials that meet cable burn tests, such as fluoropolymers like FEP in the case of plenum cables tested per the requirements of NFPA 262 and flame retardant polyolefins in the case of riser cables which are tested per UL 1666. In other applications, such barriers also need to meet requirements for standards such as tests for Low-Smoke, Zero-Halogen or other burn tests similar to UL 1666 or NFPA 262.

However, such flame retardant insulative materials are typically halogenated and release toxic halogens when burned. Fluoropolymers in particular melt and drip when burned. Also, fluoropolymers are typically more expensive due to high demand.

Therefore, a need exists for cable components that meet industry standard burn requirements and that are less toxic and less expensive.

### SUMMARY OF THE INVENTION

Accordingly, the present invention provides a cable component that comprises a main body where at least a part of the main body is formed of an insulation material, and at least one non-flammable portion is disposed in the insulation material of the main body. The non-flammable portion forms at least about 25% by volume of the cable component, is flexible, and reduces the amount of the insulation material of the main body, thereby reducing the fuel load in the cable component.

The present invention also relates to a cable that comprises a plurality of twisted pairs of insulated conductors and a separator that is configured to separate the plurality of twisted pairs of insulated conductors. The separator includes a main body that has channels which each retain one of the plurality of twisted pairs of insulated conductors, respectively. The main body is formed of an insulation material that is flame retardant. At least one non-flammable portion is disposed in the insulation material of the main body. The at least one non-flammable portion reduces the amount of the insulation material of the main body, thereby reducing the fuel load of the separator. An outer jacket surrounds the plurality of twisted pairs of insulated conductors and the separator.

The present invention also provides a cable that comprises a plurality of twisted pairs of insulated conductors and a separator that is configured to separate the plurality of twisted pairs of insulated conductors. The separator includes a main body that has channels, each of which retains one of the plurality of twisted pairs of insulated conductors. The main body is formed of a highly flame retardant insulation material. A plurality of flexible fiberglass portions are disposed in the insulation material of the main body. The plurality of flexible fiberglass portions reduce the amount of the insulation material of the main body, thereby reducing the fuel load of the separator. An outer jacket surrounds the plurality of twisted pairs of insulated conductors and the separator, such that the flexible fiberglass portions form at least about 25% by volume of said separator.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a cross-sectional view of a prior art cable and separator;

FIG. 2 is a cross-sectional view of a cable component according to a first exemplary embodiment of the present invention;

FIG. 3 is a cross-sectional view of a cable component according to a second exemplary embodiment of the present invention;

FIG. 4A is a cross-sectional view of a cable component according to a third exemplary embodiment of the present invention;

FIG. 4B is a partial perspective view of the cable component illustrated in FIG. 4A;

FIG. 5 is a cross-sectional view of a cable component according to a fourth exemplary embodiment of the present invention;

FIG. 6 is a cross-sectional view of a cable component according to a fifth exemplary embodiment of the present invention; and

FIG. 7 is a cross-sectional view of a cable component according to a sixth exemplary embodiment of the present invention.

### DETAILED DESCRIPTION OF THE INVENTION

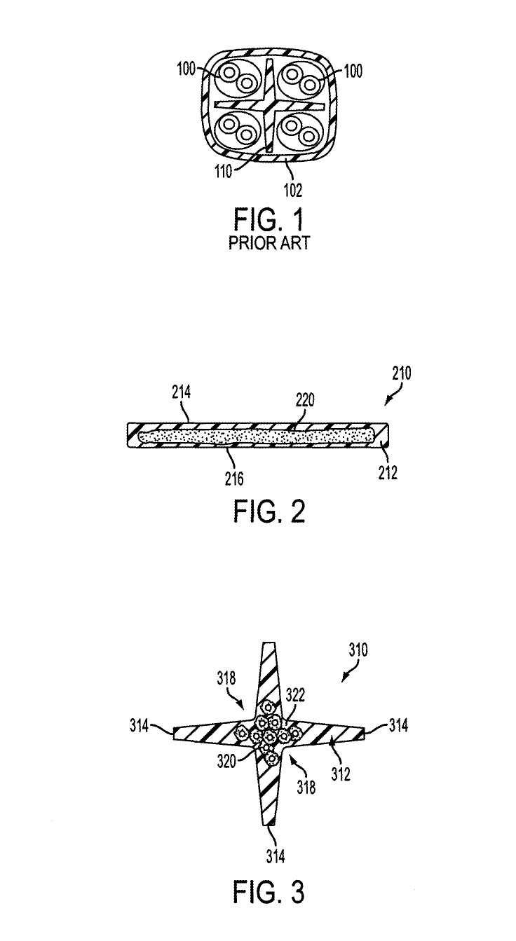

Referring to FIGS. 2, 3, 4A, 4B, and 5-7, a cable component, such as a separator, according to exemplary embodiments of the present invention, incorporates a non-flammable material, such as fiberglass, therein to provide improved burn properties and heat resistance to the cable component. The non-flammable material may be individual glass fibers bunched together, fiberglass yarns, fiberglass rovings, chopped fiberglass, woven fiberglass tapes or sheets, and the like. These materials are desirable because they have optimal burn properties while also allowing the cable component to maintain flexibility. Other suitable non-flammable materials can also be employed, such as basalt fibers, yarns, woven tapes, high temperature ceramic oxide fibers, other ceramic mica tapes, and the like. These materials are desirable because of their high temperature performance in cable applications. The non-flammable material replaces and thus reduces the amount of the fuel burning materials, such as FEP or polyolefin, of the separator, thereby improving the burn performance of the separator. The separators of the exemplary embodiments are preferably at least about 25% by volume non-flammable material.

In the case of plenum applications in particular, halogenated fluoropolymers of the cable component are displaced by the non-flammable material without sacrificing burn performance. That significantly reduces the content of costly and potentially hazardous halogenated materials in the cable. Also, many fluoropolymers when under extreme heat tend to melt and drip onto surfaces where they continue to smoke rather than burn cleanly. The non-flammable material, e.g. fiberglass, which replaces at least a portion of the fluoropolymers, limits the amount of molten material that can drip from the cable and smoke when heated. Also, in the present invention, it is possible to construct a flame retardant polyolefin separator in plenum applications by incorporating the non-flammable material therein to provide improved burn properties and heat resistance. Typically flame retardant polyolefins cannot be used for plenum applications to meet standard requirements because they typically tend to allow more flame spread than fluoropolymers. However, because the non-flammable material significantly reduces the amount of flame retardant polyolefin that would be needed in the cable component, it is now possible to use the lower cost non-fluoropolymer materials, such as polyolefin, and still maintain the smoke and flame spread performance required to meet the NFPA 262 tests. Furthermore, it is also possible with the present invention to construct a low-smoke, zero-halogen plenum grade pair separator and still meet the requirements of the NFPA 262 test.

In the case of riser applications where the requirements mandate limited vertical flame spread, burn performance of the cable component can be significantly improved by the addition of the non-flammable material according to the present invention. And because of the excellent burn properties of fiberglass, for example, the amount of flame retardants needed to meet requirements for riser applications is significantly reduced. In general, the excellent burn properties of the fiberglass also exceed those of the flame-retardant polyolefins, thereby improving overall performance in the riser burn test. Also, because of the reduction in fuel load resulting from displacing polymer material in the separator with the non-flammable material, like fiberglass, flame retardants elsewhere in the cable can be reduced. That allows for a reduction in the amount of flame retardants used in the outer jacket and insulation materials as well as other cable components, such as barrier tapes in shielded cables.

FIG. 2 illustrates a cable component or separator 210 according to a first exemplary embodiment of the invention. The separator 210 acts to isolate the pairs 100 in the cable. As an example, one or more pairs 100 may be located in the cable adjacent on one side 214 of the separator 210 and one or more pairs 110 may be located adjacent the other side 216 of the separator 210. The separator 210 has a main body 212 that is substantially flat. For example, the separator's main body 212 may be a tape. The main body 212 is preferably made of an insulation material, such as a flame retardant polymer, like FEP or a highly flame retardant halogen-free polyolefin. Incorporated in the main body 212 is the non-flammable material or portion 220 that preferably extends for the length of the separator. The non-flammable portion 220 is preferably flexible. For example, the non-flammable material 220 may be formed of a plurality of strands, such as fiberglass, that displace a portion of the insulation material of the main body 212 while maintaining the flexibility of the separator 210. As seen in FIG. 2, the non-flammable portion 220 is about 80% of the separator 210.

As seen in FIG. 3, a cable component or separator 310 according to a second exemplary embodiment of the present invention may be used to separate the pairs 100 of the cable similar to the separator 110 of FIG. 1. The separator 310 has a main body 312 with a generally cross-web shape in cross-section that includes a plurality of arms 314. The arms 314 extend from a center 322 of the separator 310 and may taper. Channels 318 are defined between the arms 314 for receiving the pairs 100. Like the separator of the first embodiment, the main body 312 is preferably made of an insulation material. Provided in the center 322 of the separator 310 is the non-flammable portion 320 that preferably extends for the length of the separator. The non-flammable portion 320 may be, for example, a plurality of bundles of strands, such as fiberglass strands. The non-flammable portion 320 also preferably forms about 50% by volume of the separator 310.

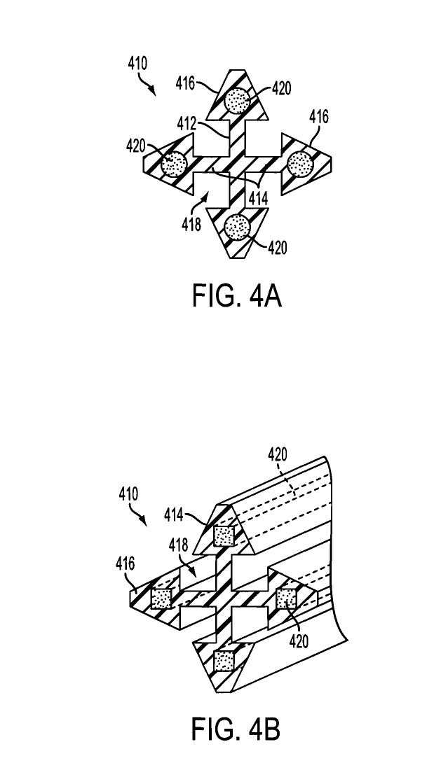

As seen in FIGS. 4A and 4B, a cable component or separator 410 according to a third embodiment of the present invention has a main body 412 with a generally cross-web shape in cross-section that includes a plurality of arms 414. The main body 412 is preferably made of a flame retardant insulation material similar to the first and second embodiments.

Each arm 414 of the separator 410 preferably has an enlarged end section 416. The enlarged end sections 416 may have any cross-sectional shape, such as triangular, as seen in FIG. 4A. Channels 418 are defined between the enlarged end sections 416 and the arms 414 that are configured to individually receive the pairs 100. Disposed in each end section 416 may be a non-flammable portion 420. The non-flammable portions 420 extend through the length of the separator 210, as seen in FIG. 4B. Each non-flammable portion 420 may have any cross-sectional shape, such as substantially circular (FIG. 4A) or substantially square (FIG. 4B). Although it is preferable that each end section 416 of the arms 414 includes the non-flammable portion 420, any number of the end sections 416 may have the non-flammable portion 420 including just one end section 416.

As seen in FIG. 5, a cable component 510 according to a fourth exemplary embodiment of the present invention is a separator that includes a main body 512 that has a substantially cross-web shape in cross-section. The main body 512 is preferably made of a flame retardant polymer like previous embodiments and includes a plurality of arms 514. The arms 514 extend from a center 522 of the separator and may taper. Channels 518 are defined between the arms 514 for receiving the pairs 100.

Each arm 514 of the separator 510 may have a non-flammable portion 520 extending for the length of the separator, similar to the non-flammable portions 220 of the first embodiment. Each non-flammable portion 520 preferably has a generally flat shape that is substantially linear in cross-section, as seen in FIG. 5. Each non-flammable portion 520 preferably extends approximately the width of each arm 514, leaving the center 522 of the separator free of the non-flammable material. However, any portion of the arms 514 may include the non-flammable portion 520. Alternatively, the non-flammable portion 520 may also be added to the center 522 of the separator. For example, one non-flammable portion 520 may span across two arms 514 and through the center 522. Although it is preferable that each arm 514 include its own non-flammable portion 520, any number of the arms 514 may include the non-flammable portion 520, including just one arm 514.

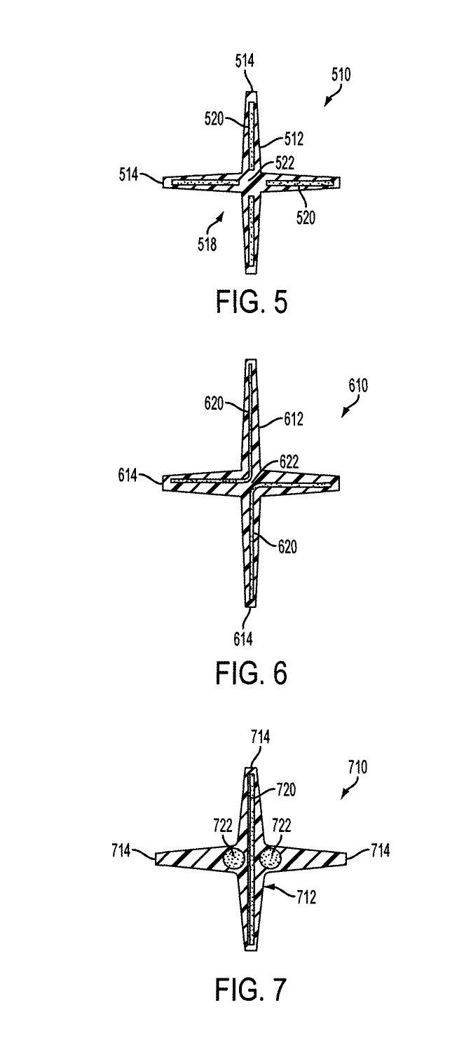

As seen in FIG. 6, a cable component or separator 610 according to a fifth exemplary embodiment of the present invention is similar to the separator 510 of the fourth embodiment, except that the non-flammable portions 620 span more than one arm 614 of the separator 610. Like the separator 510 of the fourth embodiment, the separator 610 of the fifth embodiment has a main body 612 with a cross-web shape that includes a plurality of arms 614. Non-flammable portions 620 are each disposed in two of the arms 614 and the center 622 of the separator, such that each portion 620 has a substantially L-shape in cross-section, as seen in FIG. 6. Each non-flammable portion 620 preferably extends for the length of the separator 610. Although it is preferable to use at least two non-flammable portions 620, as illustrated in FIG. 6, only one non-flammable portion 620 may be used.

As seen in FIG. 7, a cable component or separator 710 according to a sixth exemplary embodiment of the present invention combines aspects of the previous embodiments. In particular, the separator 710 has a generally cross-web shape similar to the second, fourth and fifth embodiments. The separator 710 has a main body 712 that incorporates non-flammable portions 720 and 722. The non-flammable portion 720, for example, may be generally flat with a substantially linear cross-section that spans two arms 714 of the main body 712. On either side of the flat non-flammable portion 720 may be non-flammable portions 722 that preferably form bundles of fibers or strands woven into a flat fabric and folded into L-shape then disposed in the other two arms of the separator 710. As with the other embodiments, the non-flammable portions 720 and 722 are preferably flexible and not rigid.

While particular embodiments have been chosen to illustrate the invention, it will be understood by those skilled in the art that various changes and modifications can be made therein without departing from the scope of the invention as defined in the appended claims. For example, any separator may incorporate the non-flammable material or portion as taught by the present invention and are not limited to the embodiments described above. Additionally, any combination of the above non-flammable portions may be incorporated into the separator. Also, other cable components, such as barriers, wraps and fillers, may incorporate fiberglass, as taught by the present invention.

What is claimed is:

1. A cable component, comprising:
a main body, at least a part of said main body being formed of an insulation material; and
at least one non-flammable portion disposed in said insulation material of said main body, said non-flammable portion forming at least about 25% by volume of the cable component, said at least one non-flammable portion being flexible, and said at least one non-flammable portion reducing the amount of said insulation material of said main body, thereby reducing the fuel load in the cable component.

2. A cable component according to claim 1, wherein
said at least one non-flammable portion is one of fiberglass, bunched fiberglass fibers, fiberglass yarn, fiberglass rovings, chopped fiberglass, woven fiberglass, basalt fibers, yarn, woven tape, and ceramic oxide fibers.

3. A cable component according to claim 2, wherein
said main body includes a plurality of arms, and said at least one non-flammable portion is disposed in at least one of said arms.

4. A cable component according to claim 2, wherein
said main body includes a plurality of arms, and said non-flammable portion is disposed in two of said arms.

5. A cable component according to claim 2, further comprising
a plurality of non-flammable portions disposed in said insulation material of said main body, and said plurality of said non-flammable portions forming at least about 30% of the cable component.

6. A cable component according to claim 5, wherein
each of said non-flammable portions has a substantially linear cross-sectional shape.

7. A cable component according to claim 5, wherein
one of said non-flammable portions has a substantially linear cross-sectional shape, and another of said non-flammable portions is a bundle of fibers.

8. A cable component according to claim 5, wherein
each of said non-flammable portions has either a substantially circular or square cross-sectional shape.

9. A cable component according to claim 5, wherein
said main body includes a plurality of arms, each of said plurality of arms includes an enlarged end section, and each of said plurality of non-flammable portions is disposed in each of said end sections, respectively.

10. A cable component according to claim 2, wherein
said non-flammable portion has a substantially L-shape in cross-section.

11. A cable component according to claim 2, wherein
said insulation material is a highly flame retardant halogen free polyolefin.

12. A cable component according to claim 2, wherein
said main body is a tape.

13. A cable component according to claim 1, wherein
said non-flammable portion is a bundle of fiberglass fibers disposed near a center of said main body.

14. A cable, comprising:
a plurality of twisted pairs of insulated conductors;
a separator configured to separate said plurality of twisted pairs of insulated conductors, said separator including,
a main body having channels for retaining said plurality of twisted pairs of insulated conductors, respectively, said main body being formed of an insulation material, said insulation material being flame retardant, and
at least one non-flammable portion disposed in said insulation material of said main body, said at least one non-flammable portion reducing the amount of said insulation material of said main body, thereby reducing the fuel load of said separator; and
an outer jacket surrounding said plurality of twisted pairs of insulated conductors and said separator.

15. A cable according to claim 14, wherein
said at least one non-flammable portion is one of fiberglass, bunched fiberglass fibers, fiberglass yarn, fiberglass rovings, chopped fiberglass, woven fiberglass, basalt fibers, yarn, woven tape, and ceramic oxide fibers.

16. A cable according to claim 15, wherein
said at least one non-flammable portion forms at least about 30% of said separator.

17. A cable according to claim 15, wherein
said main body includes a plurality of arms, and said at least one non-flammable portion is disposed in at least one of said arms.

18. A cable according to claim 15, further comprising
a plurality of non-flammable portions disposed in said insulation material of said main body.

19. A cable according to claim 18, wherein
each of said non-flammable portions has a substantially linear cross-sectional shape or is a bundle of fibers.

20. A cable according to claim 18, wherein
each of said non-flammable portions has either a substantially circular or square cross-sectional shape.

21. A cable according to claim 18, wherein
said main body includes a plurality of arms, each of said plurality of arms includes an enlarged end section, and each of said plurality of non-flammable portions is disposed in each of said end sections, respectively.

22. A cable according to claim 15, wherein
said non-flammable portion has a substantially L-shape in cross-section.

23. A cable according to claim 15, wherein
said insulation material is a highly flame retardant halogen free polyolefin.

24. A cable component according to claim 15, wherein
said main body is a tape.

25. A cable according to claim 15, wherein
said main body of said separator is a cross-web with four arms defining said channels;
a plurality of non-flammable portions are disposed in said insulation material of said main body of said separator such at least one of said plurality of non-flammable portions is disposed in each of said four arms, respectively.

26. A cable, comprising:
a plurality of twisted pairs of insulated conductors;
a separator configured to separate said plurality of twisted pairs of insulated conductors, said separator including,
a main body having channels for retaining said plurality of twisted pairs of insulated conductors, respectively, said main body being formed of an highly flame retardant insulation material,
a plurality of flexible fiberglass portions disposed in said insulation material of said main body, said plurality of flexible fiberglass portions reducing the amount of said insulation material of said main body, thereby reducing the fuel load of said separator; and
an outer jacket surrounding said plurality of twisted pairs of insulated conductors and said separator,
wherein said flexible fiberglass portions form at least about 25% by volume of said separator.
